(19) United States
(12) Patent Application Publication
(10) Pub. No.: US 2022/0342381 A1
(43) Pub. Date: Oct. 27, 2022

(54) MANAGING A MACHINE TOOL METHOD, FOR EXAMPLE METHOD OF MAPPING TOOLPATH DATA AND MACHINE CODE, A CONTROL DEVICE, AND A MACHINE TOOL

(71) Applicant: Siemens Industry Software Inc., Plano, TX (US)

(72) Inventors: Thomas Feind, Hennigsdorf (DE); Jeremy Wight, Saint Paul, MN (US); Volker Grabowski, München (DE)

(21) Appl. No.: 17/238,628

(22) Filed: Apr. 23, 2021

(51) Int. Cl. G05B 19/402; G05B 19/408; G05B 19/409; G05B 19/4069

(52) U.S. Cl. CPC G05B 19/402; G05B 19/408; G05B 19/409; G05B 19/4069

(57) ABSTRACT

A computer-implemented method includes receiving toolpath data for machining a workpiece with a tool along a toolpath. The tool is comprised by a machine tool that is numerically controlled by a control device. Machine code for the machine tool corresponding to the toolpath data is received. A map linking at least one item of the toolpath data and at least one item of the machine code corresponding to the least one item of the toolpath data is created. At least one first item of the toolpath data and one or more second items of the machine code corresponding to the at least one first item are displayed to a user using the created map. A control device and a machine tool arranged and configured to execute the computer-implemented method are also provided.

### TECHNICAL FIELD

The present disclosure is directed, in general, to machining where materials, e.g. extremely hard materials, have to be machined, e.g. by cutting, boring, grinding, shearing, or other forms of deformation including additive manufacturing. For such purposes, machine tools are used, whereby such machine tools are generally controlled numerically by a control device or processor, and whereby software solutions for computer-aided design/manufacturing/engineering (CAD/CAM/CAE) are used to support or control the machining process (collectively referred to herein as product systems).

### BACKGROUND

Machine tools, such as lathes, milling machines, etc., are widely used to machine workpieces. Generally, such machine tools include a tool for machining the workpiece and are numerically controlled by a control device. Machining a workpiece regularly involves comprehensive and time-consuming preparatory steps to provide a good quality of the machined workpiece, to avoid an excessive tool wear, and to provide efficiency with respect to time and costs.

The present embodiments generally relate to machining of workpieces using machine tools, such as to manage a machine tool.

Currently, there exist product systems and solutions that support machining of workpieces using machine tools and managing a machine tool. Such product systems may benefit from improvements.

### SUMMARY AND DESCRIPTION

Variously disclosed embodiments include methods, control devices, and machine tools that may be used to facilitate machining of workpieces using machine tools, and, for example, to facilitate managing a machine tool.

According to a first aspect of the present embodiments, a computer-implemented method is provided, where the method may include: receiving toolpath data for machining a workpiece with a tool along a toolpath, where the tool is comprised by a machine tool that is numerically controlled by a control device; receiving machine code for the machine tool corresponding to the toolpath data; creating a map linking at least one item of the toolpath data and at least one item of the machine code corresponding to the least one item of the path data; and displaying at least one first item of the toolpath data and the one or more second items of the machine code corresponding to the at least one first item to a user using the created map.

By way of example, the described computer-implemented method may be carried out through operation of the control device, the machine tool, and/or at least one processor.

For example, the toolpath data and/or the machine code may be provided to the control device or to the machine tool by a user (e.g., using via a graphical user interface (GUI), an input device, a display, or the like). In another example, the toolpath data and/or the machine code may be provided to the control device or to the machine tool by transmitting corresponding data from a design software, e.g. computer-aided design (CAD), computer-aided manufacturing (CAM), product lifecycle management (PLM) software, manufacturing operations management (MOM) software, or other suitable software.

In an embodiment, the control device and/or the machine tool includes at least one processor and/or a numerical controller arranged and configured to carry out the method acts.

According to a second aspect of the present embodiments, a control device for numerically controlling a machine tool that includes a tool for machining a workpiece along a toolpath is provided. The control device (e.g., a processor of the control device) is arranged and configured to carry out the described method.

According to a third aspect of the present embodiments, a machine tool is provided. The machine tool includes a tool for machining a workpiece along a toolpath and the described control device for numerically controlling the machine tool.

According to a fourth aspect of the present embodiments, a computer-readable medium (e.g., a non-transitory computer-readable storage medium) encoded with executable instructions, that when executed, cause the described control device or machine tool to carry out the described method is provided. By way of example, the described computer-readable medium may be non-transitory and may further be a software component on a storage device.

The foregoing has outlined rather broadly the technical features of the present disclosure so that those skilled in the art may better understand the detailed description that follows. Additional features and advantages of the disclosure will be described hereinafter. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Various definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIGS. 1 and 2 illustrate a diagram of an example product system that facilitates machining of workpieces using a machine tool.

FIG. 3 illustrates an example toolpath for machining a workpiece using a product system shown in FIG. 1 or FIG. 2.

FIG. 4 illustrates an example flow diagram for the generation of machine code from toolpath data.

FIG. 5 illustrates an example flow diagram for the creation of a map.

FIG. 6 illustrates a flow diagram of an example methodology that facilitates machining of workpieces using a machine tool in a product system.

FIG. 7 illustrates a block diagram of a data processing system in which an embodiment may be implemented.

### DETAILED DESCRIPTION

Various technologies that pertain to systems and methods for machining of workpieces using a machine tool, in particular managing a machine tool, in a product system will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present patent document will be described with reference to exemplary non-limiting embodiments.

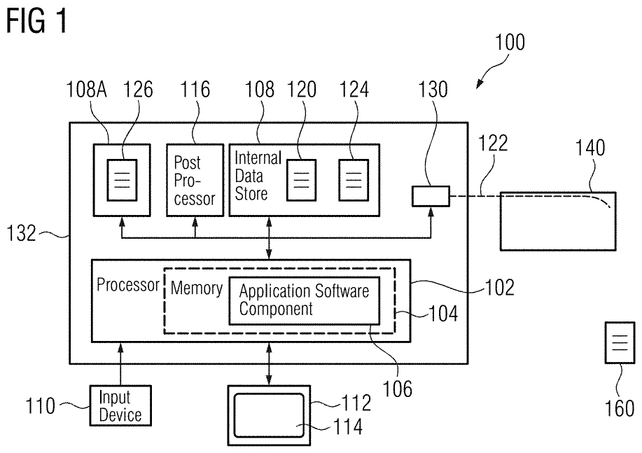

With reference to FIG. 1, a functional block diagram of an example product system or data processing system 100 that facilitates machining of a workpiece 140 using a machine tool 132 is illustrated. The processing system 100 may include a machine tool 132 including at least one processor or control device 102 that is configured to execute at least one application software component 106 from a memory 104 accessed by the processor 102. The application software component 106 may be configured (i.e., programmed) to cause the processor 102 to carry out various acts and functions described herein. For example, the described application software component 106 may include and/or correspond to one or more components of a machine tool control application that is configured to generate and store product data in a data store 108 such as a database.

To enable the enhanced machining of a workpiece 140, the described product system or data processing system 100 may include at least one input device 110 and at least one display device 112 (e.g., a display screen). The described processor 102 may be configured to generate a GUI 114 through the display device 112. Such a GUI 114 may include GUI elements such as buttons, links, search boxes, lists, text boxes, images, scroll bars usable by a user to provide inputs through the input device 110 that cause machining of a workpiece 140. The input device 110 and/or the display device 112 may be comprised by the machine tool 132 or be arranged separate from the machine tool 132, e.g., so that the input device 110 and/or the display device 112 are comprised by a computer system, such as a CAD, CAM, PLM, or MOM system.

For the facilitated machining of a workpiece 140 using a machine tool 132, the machine tool 132 may include a tool 130 for machining the workpiece 140 along a toolpath 122. The tool 130 may be numerically controlled by the processor or control device 102 of the machine tool 132. Herein, machining may include among others processes in which a material (e.g., metal) is cut into a desired final shape and size by a controlled material-removal process. The processes that have this common theme, controlled material removal, are today collectively known as subtractive manufacturing and may include milling or turning. In the context of the present patent document, machining may further include additive manufacturing processes, i.e. processes of controlled material addition. The tool 130 may then add material (e.g., layers of material) to the workpiece 140.

In an example embodiment, the application software component 106 and/or the processor 102 may be configured to receive toolpath data 120 for machining a workpiece 140 with a tool 130 along a toolpath 122, where the tool 130 is comprised by a machine tool 132 that is numerically controlled by a control device 102. The toolpath data 120 corresponding to the toolpath 122 may be provided, e.g., by a user using, e.g. via the GUI 114, the input device 110, the display device 112, or the like. Alternatively or additionally, the toolpath data 120 may be provided by transmitting corresponding data from a design-aided design (CAD) software, a computer-aided manufacturing (CAM) software, product lifecycle management (PLM) software, or other suitable software to the control device 102 or the present product system 100. Herein, the toolpath data 120 may be provided to the processor 102 and/or to the data store 108 where the toolpath data 120 may be stored.

By way of example, the tool 130 may be moved or positioned by the control device 102, where the tool 130 may in some examples include a cutter for subtractive manufacturing or a printer head or light-emitting device for additive manufacturing. In some examples, a toolpath data 120 may include a geometric toolpath 122, such as circles and lines, along which the tool 130 is moved. The toolpath data 120 may further include non-geometric information, such as events that may describe technological properties, such as a speed specification or a linear movement in X, Y or Z direction of the tool 130 necessary to produce the geometric basic elements.

Further, the application software component 106 and/or the processor 102 may be configured to receive machine code 124 for the machine tool 132 corresponding to the toolpath data 120. The machine code 124 may be machine-specific process information required by the machine tool 132 for machining the workpiece 140 along the toolpath 122. Using available toolpath data 120, a post processor 116 may be used to determine the corresponding machine code 124. A post processor 116 may be a unique “driver” specific to a machine tool 132, a computer numerical control (CNC) machine, a robot, or a mechanism. The post processor 116 may work with the CAM software or off-line programming software to make sure the machine code 124, such as G-Code, output, or program is correct for a specific machine control cabinet. Herein, the CAD model of the desired workpiece 140 may be analyzed to determine what tooling and toolpaths 122 will be used to machine the desired features. Doing so may require a CAM post processor 116 that generates the exact machine or G-code. A post processor 116 may be a software subroutine (e.g., sub-program) that converts graphical or non-graphical CAM software toolpath data 120 into machine code 124. By way of example, the machine code 124 may be provided to the processor 102 and/or to the data store 108, where the machine code 124 may be stored.

In an example embodiment, the application software component 106 and/or the processor 102 may further be configured to create a map 126 linking at least one item of the toolpath data 120 and at least one item of the machine code 124 corresponding to the least one item of the toolpath data 120. In some examples, the created map 126 may be one or a number of associations of the toolpath data 120 with machine code 124. Such a map may have the form of a list in which single or a number of items of the toolpath data 120 are linked with single or a number of items of machine code 124. To create the map, a mapper software component that may store the toolpath data 120 and the machine code 124 in the map 126 may be used. This may be done, for example, by storing the input data of the post processor 116 (e.g., the toolpath data 120) and the output state of the post processor 116 (e.g., the machine code 124 and the map 126). The map 126 may be stored in a data store 108A that is comprised by the machine tool 132. In some examples, the map 126 may be stored in the internal data store 108 in which the toolpath data 120 and the machine code 124 are stored.

According to other embodiments, the determination of machine code 124 by the post processor 116 is a one-way process during which the toolpath data 124 input is not stored and hence not directly accessible for subsequent processing or managing steps. The advantage of the created map 126 is that both the machine code 124 and the toolpath data 120 are directly accessible and that the links and correlations between distinct items of toolpath data 120 and distinct items of machine code 124 are stored and also directly accessible.

In some examples, the application software component 106 and/or the processor 102 may further be configured to display at least one first item of the toolpath data 120 and the one or more second items of the machine code 124 corresponding or linked to the at least one first item to a user using the created map 126. Displaying one or a number of the toolpath data 120 items and the corresponding machine code 124 item(s) may be done via the display device 112 and the GUI 114 and is of particular advantage and value for an operator or a user of the machine tool 132 or a computer system, such as a CAD, CAM, PLM, or MOM system, since this facilitates troubleshooting and optimizing the toolpath 122. This approach is advantageous since the display of toolpath data 120 item(s) and the corresponding machine code 124 item(s) may directly be done without re-running the post processor 116. Since post processing is a time- and resource consuming process, the suggested approach is faster, less resource consuming, and allows for direct interaction of the user or operator with the machine tool 132 or the computer system.

Equivalently, at least one second item of the machine code 124 and the one or more first items of the toolpath data 120 linked to the at least one second item may be displayed to a user using the created map 126. Further, in some examples, the corresponding toolpath 122 may be displayed to a user.

By way of example, according to other approaches, already minor amendments made to the toolpath data 120 require to re-run the post processor 116 and hence to wait for a certain period of time until the corresponding machine code 124 is available and may be displayed. Sometimes re-running the post processor 116 is even done in other approaches, although amendments made to the toolpath data 120 do not even result in amended machine code 124, but result in the same machine code 124 that has been available before such an amendment of the toolpath data 120. Contrary to these other approaches, in the suggested approach, machine code 124 that has already been determined by the post processor 116 may be reused without re-running the post processor 116. This is enabled by the created map 126, which includes both the tool path data 120 and the machine code 124.

Hence, according to the suggested approach, the interaction of user or operator of the machine tool 132 or computer system is considerably enhanced, which allows a user or operator to understand the relation between toolpath data 120 item(s) and the corresponding machine code 124 item(s) faster and therefore optimize the toolpath data 120 and/or the machine code 124 faster and more conveniently.

By way of example, the machine tool 132 may then be operated such that the control device 102 controls the tool 130 machine the workpiece 140 along the toolpath 122 using the machine code 124.

In some examples, the toolpath data 120 includes geometry information on the trajectory along which the tool 130 is to be moved, where the machine code 124 includes commands that may be interpreted by the control device 102.

The geometry information on the trajectory may include information on straight lines, circles, sinus shapes, hyperbolic curves, etc. along which the tool 130 is to be moved. The toolpath data 120 may further include non-geometric data, such as feeds, e.g. in mm/min, indicating the velocity of the tooltip, or such as speeds, e.g., in rounds per minute, indicating a rotation speed of a cutter or spindle. Herein, feeds may be linear speeds or velocity vectors, and speeds may be spindle rotation speeds. In some examples, the toolpath data 120 may also indicate whether a rapid move for a patching move is to be done.

By way of example, the machine code 124 may include or consist of G-code, also known as RS-274, a widely used computer numerical control (CNC) programming language. G-code is used mainly in computer-aided manufacturing to control automated machine tools and has many variants. The machine code 124 or the G-code instructions may be provided to the control device 102 and may tell the motors of the machine tool 132 where to move, how fast to move, and what path to follow. The two most common situations are that, within a machine tool 132 such as a lathe or mill, a cutting tool 130 is moved according to these instructions through a toolpath 122 cutting away material to leave only the finished workpiece 140 and/or, an unfinished workpiece 140 is precisely positioned in any of up to nine axes around the three dimensions relative to a toolpath 122, and either or both may move relative to each other. The same concept also extends to noncutting tools 130 such as forming or burnishing tools, photo plotting, additive methods such as 3D printing, and measuring instruments.

By way of example, receiving the machine code 124 for the machine tool 132 may include determining the machine code 124 based on the toolpath data 120 using a post processor software component 116, where the application software component 106 and/or the processor 102 may further be configured to simultaneously determine the machine code 124 using the post processor software component 116 and create the map 126.

According to this example, the machine code 124 is determined with the post processor 116, and at the same time, the map 126 is created and populated with toolpath data 120.—As soon as the post processor 116 provides the corresponding machine code 124 as an output, the corresponding machine code 124 is determined. Hence, determining the machine code 124 may be completed slightly earlier than creating the map 126; however, the toolpath data 120 and the corresponding entries of the machine code 124 may be used to create the map 126, whereby these entries of the machine code 124 are used as soon as the entries are available as output from the post processor 126. Accordingly, as soon as the post processor 116 has completed the determination of the machine code 124, the map may be completed with negligible time delay. Therefore, in this context, the determination of the machine code 124 by the post processor 116 and the creation of the map 126 may be understood as simultaneous.

Besides the toolpath data 120, the post processor 116 may further use additional data relating to the machine tool 132 to determine the machine code 124.

In some examples, the application software component 106 and/or the processor 102 may further be configured to: capture a user input relating to an amendment of at least one of the displayed first items of the toolpath data 120; determine amended machine code 124′ corresponding to the amended toolpath data 120′ using the created map 126; update the map 126 to an updated map 126′ linking the at least one amended first item of the amended toolpath data 120′ and one or more amended second items of the amended machine code 124′ corresponding to the least one amended first item of the amended toolpath data 120′; and display at least the amended first item of the amended toolpath data 120′ and one or more amended second items of the amended machine code 124′ linked to the least the amended first item using the updated map 126′.

By way of example, the user may provide the user input using the input device 110 when interacting with the GUI 114 displayed at the display device 112. Through user interaction, the user may provide input indicating an amendment of the toolpath data 120, e.g. by amending one or several items of the toolpath data 120 to obtain amended toolpath data 120′. Based on the user input, this amended toolpath data 120′ may be determined, e.g. by using the created map 126. In some examples, the user may directly edit the toolpath data 120 to obtain the amended toolpath data 120′. Based on the amended toolpath data 120′, amended machine code 124′ that corresponds to the amended toolpath data 120′ may be determined. This determination may be done using the created map 126 or other support tools. Hence, this determination may be done without re-running the post processor 116, which makes this a fast process that is not consuming many resources.

The map 126 may then be updated to obtain an updated map 126′ linking the amended item(s) of the amended toolpath data 120′ and the one or more amended items of the amended machine code 124′ corresponding to the amended item(s) of the amended toolpath data 120′. Using the updated map 126′, the amended item(s) of the amended toolpath data 120′ and the amended item(s) of the amended machine code 124′ corresponding to the amended item(s) of the amended toolpath data 120′ may then be displayed, e.g. on the GUI 114 of the display device 112. In some examples the originally created map 126 may also be used. In further examples, by comparing the originally created map 126 and the updated map 126′, these amended items of amended toolpath data 120′ and of amended machine code 124′ replace the previous corresponding items of toolpath data 120 and machine code 124.

According to this aspect of the present embodiments, a direct and interactive update and amendment of toolpath data 120 is enabled such that the resulting amended machine code 124′ may quickly be determined and displayed to the user. The time- and resource-consuming step of post processing may not be necessary for this aspect.

In further examples, the application software component 106 and/or the processor 102 may further be configured to: capture the user input relating to an amendment of at least one of the displayed second items of the machine code 124; determine amended toolpath data 120′ corresponding to the amended machine code 124′ using the created map 126; update the map 126 to an updated map 126′ linking the at least one amended second item of the amended machine code 124′ and one or more amended first items of the amended toolpath data 120′ corresponding to the least one amended second item of the amended machine code 124′; and display at least the amended second item of the amended machine code 124′ and the one or more amended first items of the amended toolpath data 120′ linked to the least the amended second item using the updated map 126′.

By way of example, the user may provide the user input using the input device 110 when interacting with the GUI 114 displayed at the display device 112. Through user interaction, the user may provide input indicating an amendment of the machine code 124, e.g. by amending one or several items of the machine code 124 to obtain amended machine code 124′. Based on the user input, this amended machine code 124′ may be determined, e.g. by using the created map 126. In some examples, the user may directly edit the machine code 124 to obtain the amended machine code 124′. Based on the amended machine code 124′, amended toolpath data 120′ that corresponds to the amended machine code 124′ may be determined. This determination may be done using the created map 126 or other support tools. Hence, this determination step may done be without re-running the post processor 116 that makes this a fast process that is not consuming many resources.

The map 126 may then be updated to obtain an updated map 126′ linking the amended item(s) of the amended machine code 124′ and the one or more amended items of the amended toolpath data 120′ corresponding to the amended item(s) of the amended machine code 124′. Using the updated map 126′, the amended item(s) of the amended machine code 124′ and the amended item(s) of the amended toolpath data 120′ corresponding to the amended item(s) of the amended machine code 124′ may then be displayed, e.g. on the GUI 114 of the display device 112. In some examples, the originally created map 126 may also be used. In further examples, comparing the originally created map 126 and the updated map 126, these amended items of amended toolpath data 120′ and of amended machine code 124′ replace the previous corresponding items of toolpath data 120 and machine code 124.

According to this aspect of the present embodiments, a sort of reverse engineering is enabled, which may bring back machine code edits into the toolpath. Hence, according to this aspect, a direct and interactive update and amendment of machine code 124 is enabled such that the resulting amended toolpath data 120′ may quickly be determined and displayed to the user. The time- and resource-consuming step of post processing may not be necessary for this aspect.

In some examples, the application software component 106 and/or the processor 102 may further be configured to: receive machine tool data 128; create the map 126 such that the map 126 links at least one item of the toolpath data 120, the machine tool data 128, and at least one item of the machine code 124 corresponding to the least one item of the toolpath data 120 and/or the machine tool data 128; and display at least one first item of the toolpath data 120, the machine tool data 128, and the one or more second items of the machine code 124 linked to the at least one first item to a user using the created map 126.

According to this aspect of the present embodiments, machine tool data 128 is taken into account for the creation of the map 126. The machine tool data 128 may be provided directly by the machine tool 132, for example by a control device 102 or an internal data store 108 of the machine tool 132. In some examples, the machine tool data 128 characterizes the properties of the machine tool 132 and/or the status (e.g., current status) of the machine tool 132. The map 126 including this machine tool data 128, or at least selected items or entries of this map 126, may then be displayed to a user to provide more insight and to further facilitate understanding of the toolpath data 120 and/or the machine code 124 and how the toolpath data 120 and/or the machine code 124 may relate to the machine tool data 128. This enhanced understanding may then result in an optimized toolpath 122 for machining of the workpiece 140.

In some of these examples, the machine tool data 128 includes data on axis information, tool wear, tool dimensions, a used coolant, spindle, tool changer, coordinate system changes, head, or any combination thereof.

By way of example, it may be instructive for a user to see displayed information about the toolpath data 120 or the machine code 124 and about, e.g., tool dimensions or tool wear. In some examples, tool wear may need to be compensated by the determined machine code 124 so that the desired shape of the workpiece 140 may still be achieved. Such compensation may also be required for different tool sizes or tool dimensions.

In some examples, receiving the toolpath data 120 may include that the application software component 106 and/or the processor 102 may further be configured to: receive a three-dimensional start shape of the workpiece 140 and a three-dimensional target shape of the workpiece 140; and determine the toolpath data 120 based on the three-dimensional start and target shapes of the workpiece 140.

Herein, the start shape of the workpiece 140 is sometimes simply referred to as “blank”, and the target shape of the workpiece 140 is referred to as “part”. In some examples, the start shape may be input by a user, especially if the machine tool is provided with only one or a few start shapes. The target shape may be provided to machine tool 132 by a computer system, such as a CAD, CAM, PLM, or MOM system, in which the target shape of the workpiece 140 may be designed or managed. To this end, the computer system may be connected for data transmission to the machine tool 132.

The toolpath data 120 may then be determined based on the three-dimensional start shape and target shape of the workpiece 140. In some examples, this determination may be done by the post processor 116.

In further examples, the application software component 106 and/or the processor 102 may further be configured to: display a plurality of items of the toolpath data 120 to a user; capture the user input relating to a selection of at least one item of the displayed plurality of items of the toolpath data 120; simulate the machining process until/from the selected item of toolpath data 120 using the created map 126; and display the simulated machining process until/from the selected item of toolpath data 120 to the user.

According to these examples, the user may select a given item of the toolpath data 120. In some examples, this may be done by displaying the toolpath 122 to the user and the user selecting a certain point or item of the displayed toolpath 122. Then, using the created map 126, the machining process may be simulated from the start of the machining process to the selected item of toolpath data 120 or from the selected item of toolpath data 120 to the end of the machining process. By way of example, the user may indicate and select which of the two options the user wishes to select.

This aspect of the present embodiments conveniently allows the user to pick a certain toolpath 122 or a certain part of the toolpath 122, e.g., on the GUI 114, e.g. using the input device 110 or the display device 112 if the display device 112 is a touch screen. The user may then get useful information on the selected toolpath 122 or toolpath data 120 or at least relevant parts of the selected toolpath 122 or toolpath data 120.

Herein, the simulation may be performed by a computer system, such as a CAD, CAM, PLM, or MOM system, the machine tool 132 if suitably equipped, or equivalent. The toolpath 122 may be simulated using the created map 126, e.g. based on the toolpath data 120 and, if required, corresponding machine code 124. Since re-running the post processor 116 may be avoided, the simulation step may be performed comparably quickly so that a user gets fast feedback that facilitates the interaction of the user with the machine tool 132 or computer system. Rather, the created map 126 may be used to determine the corresponding item of machine code 124 and, e.g., a corresponding timestamp, to/from which the simulation shall be performed.

The simulated toolpath 122 or toolpath data 120 as selected by the user may then be displayed to the user, e.g. using the GUI 114 and the display device 112. This allows the user to check the toolpath 122, the toolpath data 120, and/or the corresponding machine code 124 and, if necessary, make amendments to optimize one or more of these entities. In some examples, the simulation includes information on required machining time, tool wear, forces, or torques exerted on the tool 130 or the workpiece 140, permitted maximum forces or torques exerted on the tool 130 or the workpiece 140, the rates and/or total quantity of removed or added material, expected tool and/or workpiece temperature, maximum permitted tool and/or workpiece temperature, or other quantities or pieces of information relevant for the machining of the workpiece 140. This information, such as the required machining time and/or a ratio of the exerted forces or torques with respect to the maximum permitted forces or torques may also be displayed along the simulated toolpath 122 to the user. Herein, displaying the simulated toolpath 122 or the corresponding toolpath data 120 and, if applicable, additional related information further facilitates analyzing and, if necessary, optimizing a toolpath 122, toolpath data 120, and/or machine code 124.

In other examples, the application software component 106 and/or the processor 102 may further be configured to: display a plurality of items of the machine code 124 to a user; capture the user input relating to a selection of at least one item of the displayed plurality of items of the machine code 124; simulate the machining process until/from the selected item of machine code 124 using the created map 126; and display the simulated machining process until/from the selected item of machine code 124 to the user.

According to these examples, the user may select a given item of the machine code 124. Then, using the created map 126, the machining process may be simulated from the start of the machining process to the selected item of machine code 124 or from the selected item of machine code 124 to the end of the machining process. By way of example, the user may indicate and select which of the two options the user wishes to select.

This aspect of the present embodiments conveniently allows the user to pick a certain item of machine code 124 on the GUI 114, e.g. using the input device 110 or the display device 112 if the display device 112 is a touch screen. The user may then get useful information on the selected machine code 124, the corresponding toolpath 122, the corresponding toolpath data 120, or at least relevant parts, respectively.

Herein, the simulation may be performed by a computer system, such as a CAD, CAM, PLM, or MOM system, the machine tool 132 of suitably equipped, or equivalent. The toolpath 122 may be simulated using the created map 126, e.g. based on the toolpath data 120 and, if required, corresponding machine code 124. Since re-running the post processor 116 may be avoided, the simulation step may be performed comparably quickly so that a user gets fast feedback that facilitates the interaction of the user with the machine tool 132. Rather, the created map 126 may be used to determine the corresponding item of machine code 124 or the toolpath data 120 and, e.g., a corresponding timestamp, to/from which the simulation shall be performed.

The simulated toolpath 122 or toolpath data 120 as selected by the user by taking a certain item of the machine code 124 may then be displayed to the user, e.g. using the GUI 114 and the display device 112. This allows the user to check the toolpath 122, the toolpath data 120, and/or the corresponding machine code 124 and, if necessary, make amendments to optimize one or more of these entities. In some examples, the simulation includes information on required machining time, tool wear, forces, or torques exerted on the tool 130 or the workpiece 140, permitted maximum forces or torques exerted on the tool 130 or the workpiece 140, the rates and/or total quantity of removed or added material, expected tool and/or workpiece temperature, maximum permitted tool and/or workpiece temperature, or other quantities or pieces of information relevant for the machining of the workpiece 140. This information, such as the required machining time and/or a ratio of the exerted forces or torques with respect to the maximum permitted forces are torques may also be displayed along the simulated toolpath 122 to the user. Herein, displaying the simulated toolpath 122 or corresponding toolpath data 120 and, if applicable, additional related information further facilitates analyzing and, if necessary, optimizing a toolpath 122, toolpath data 120, and/or machine code 124.

According to some exemplary embodiments, the application software component 106 and/or the processor 102 may further be configured to: determine a machine tool status based on the machine code 124 stored in the map 126; and display the determined machine tool status for a respective item of the machine code 124 to a user.

The map 126 may further be used to provide more information to the user on the status of the machine tool 132 during the course of the machining process. To this end, the machine code 124 stored in the map 126 may be used to determine the status of the machine tool 132 during the execution of each of the items of the machine code 124. This status information may then be displayed to the user so that the user may assess whether amendments to the toolpath 122, the toolpath data 120, and/or the machine code 124 is necessary. In some examples, the machine tool status includes information on tool wear, forces or torques exerted on the tool 130 or the workpiece 140, permitted maximum forces or torques exerted on the tool 130 or the workpiece 140, the rates and/or total quantity of removed or added material, expected tool and/or workpiece temperature, maximum permitted tool and/or workpiece temperature, or other quantities or pieces of information relevant for the machining of the workpiece 140.

In some examples, the application software component 106 and/or the processor 102 may further be configured to: determine the machining duration required for at least one of the items of the toolpath data 120 and/or for at least one of the items of the machine code 124 using on the respective entry(ies) in the map 126; and display the determined machining duration and the corresponding item(s) to a user.

In some examples, the determination of the machining duration or time required for the respective machining step may be performed by a computer system, such as a CAD, CAM, PLM or MOM system, the machine tool 132 of suitably equipped, or equivalent. Since re-running the post processor 116 may be avoided, this determination step may be performed comparably quickly so that a user gets fast feedback that facilitates the interaction of the user with the machine tool 132. Rather, the created map 126 or the respective entry(ies) of the map 126 may be used to determine the machining time duration for one or more item(s) of the toolpath data 120, of the machine code 124, or, if applicable, of the toolpath 122. A sequence of such items may be considered, and the corresponding machining duration for the sequence may be determined. The determined machining duration may then be displayed to the user along with the corresponding item(s).

In some examples, the user may provide input relating to the selection of the mentioned one or more item(s) of the toolpath data 120, of the machine code 124, or, if applicable, of the toolpath 122 or of the mentioned sequence of such items. Corresponding information may first be displayed to a user who may then make the desired selection.

This aspect of the present embodiments allows a user to quickly and conveniently get feedback on the machining duration per mentioned item(s) or duration, such as a given path event, motion, or line or item of machine code 124.

The above examples are equally applicable to the control device 102, to the lathe 132, and to the corresponding computer-readable medium 160 explained in the present patent document, respectively.

With reference to FIG. 2, a functional block diagram of another example product system or data processing system 100 that facilitates machining of a workpiece 140 using a machine tool 132 is illustrated.

According to this example, the product system or data processing system 100 includes a machine tool 132 including the control device or processor 102, the internal data store 108 in which the toolpath data 120 and the machine code 124 may be stored, and the post processor 116. Further, the machine tool 132 may include the input device 110 and the display device 112 for displaying the GUI 114. The machine tool 132 may further include the tool 134 machining the workpiece 140 along the toolpath 122.

Additionally, the product system or data processing system 100 may include a computer system 150, such as a CAD, CAM, PLM, or MOM system. The computer system 150 may include at least one processor 102′ that is configured to execute at least one application software component 106′ from a memory 104′ accessed by the processor 102′. The application software component 106′ may be configured (i.e., programmed) to cause the processor 102′ to carry out various acts and functions related to CAD, CAM, PLM, or MOM. The computer system 150 may further include an input device 110′ and a display device 112′ (e.g., a display screen). The described processor 102′ may be configured to generate a GUI 114′ through the display device 112′ of the computer system 150.

In some examples, the machine tool 132 and the computer system 150 are communicatively coupled so that toolpath data 120 and machine code 124 from the machine tool 132 may be communicated to the computer system 150 and then be stored in the internal data store 108′ of the computer system 150. The map 126 linking at least one item of the toolpath data 120 and at least one item of the machine code 124 corresponding to the least one item of the toolpath data 120 may be created by the computer system 150. In some examples, the created map 126 may be communicated from the computer system 150 to the machine tool 132.

The examples and embodiments explained above in the context of the product system or data processing system 100 illustrated in FIG. 1 may equally apply to the product system or data processing system 100 illustrated in FIG. 2, where the explained method acts may be carried out by the processor 102′ of the computer system 150 and/or the control device or processor 102 of the machine tool 132.

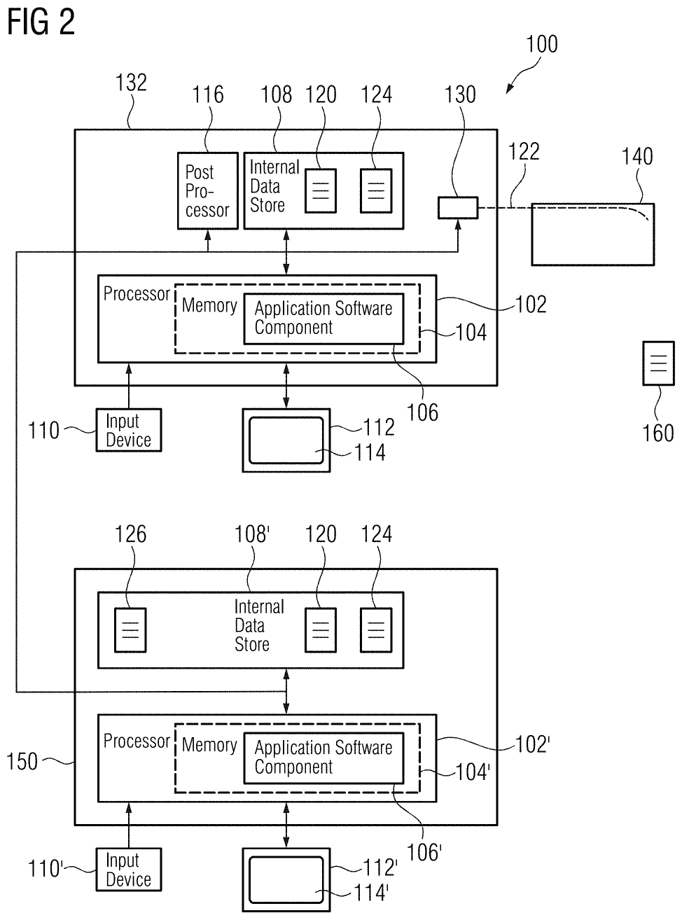

With reference to FIG. 3, an example toolpath 122 for machining a workpiece 140 using a product system 100 shown in FIG. 1 or 2 is illustrated.

The toolpath 122 may include four arcs of circles, noted as “Arc 1”, “Arc 2”, “Arc 3”, and “Arc 4”, where the endpoint of the preceding arc may be the start point of the subsequent arc. Accordingly, the tool 130 of the machine tool 132 may be moved along this toolpath 122 from the start point of “Arc 1” to the end point of “Arc 4” for machining the workpiece 140. The two first arcs “Arc 1 and “Arc 2” may have the same center point, whereas the respective center point of the two subsequent arcs may be different.

In other examples, the toolpath 122 may include a plurality of different geometric forms, such as straight lines, sinus shapes, hyperbolic curves, etc. As explained above, the toolpath data 120 may include further information relating to the toolpath 122.

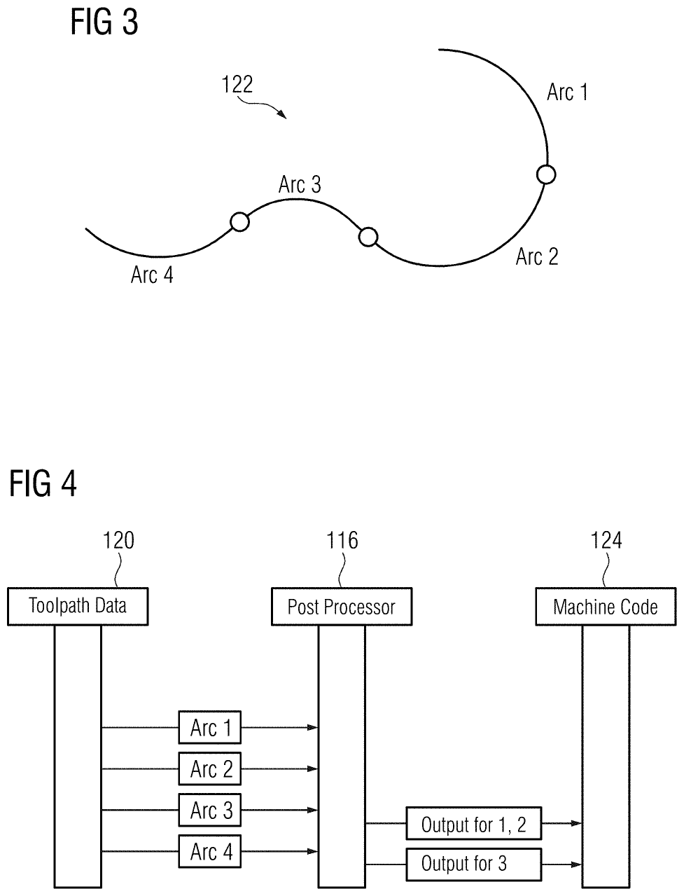

With reference to FIG. 4, an example flow diagram for the generation of machine code 124 from toolpath data 120 is illustrated.

The toolpath data 120 relating to the toolpath 122 may be used as input data. Using the toolpath 122 shown in FIG. 3, the toolpath data 120 may include information corresponding to the four arcs of circles, noted as “Arc 1”, “Arc 2”, “Arc 3”, and “Arc 4”, of the toolpath 122. The input data may be provided to a post processor 116. The post processor 116 may use the input data and determine corresponding machine code 124 as output data. For the example of the toolpath 122 including the four arcs, the post processor 116 may provide such output of machine code 124 that the two first arcs “Arc 1” and “Arc 2” may be covered by one common output of machine code 124 “Output for 1, 2” since the two arcs have exactly the same center point. The post processor 160 may further provide “Output for 3” of machine code 124 corresponding to the third arc “Arc 3” of the toolpath 122. However, for the last arc “Arc 4”, the post processor 116 may not yet be able to provide machine code 124 output since the subsequent item of the toolpath 122 is not yet known, where the subsequent event may also be the end of the toolpath. Hence, for determining the corresponding machine code 124, the post processor 116 may at least take into account a given item of the toolpath 122 or corresponding toolpath data 120 and its subsequent item so that an optimization of the machine code 124 is possible.

For example, there may be, but there does not need to be, a one-to-one-correspondence between an entry of the toolpath data 120 and an entry of the machine code 124. For the example toolpath 122 illustrated in FIG. 3, the two entries of the toolpath data 120 corresponding to the two first arcs “Arc 1” and “Arc 2” are processed such by the post processor 116 that one single entry of machine code 124 is output (e.g., “Output for 1, 2”). This is the case since the two first arcs “Arc 1” and “Arc 2” have the same center point and do not imply a change of the tool movement during the machining process. Rather, the two first arcs “Arc 1” and “Arc 2” may be combined to one uniform movement and hence to only one entry of machine code 124. This provides, in this case, that there is a two-to-one-correspondence between entries of the toolpath data 120 and an entry of the machine code 124.

In contrary, the third arc “Arc 3” has a different center point and therefore requires a separate entry of machine code 124 (e.g., “Output for 3”). Hence, for this example, there is a one-to-one-correspondence between an entry of the toolpath data 120 and an entry of the machine code 124.

For the time being, for the fourth arc “Arc 4”, the corresponding machine code 124 may not yet be determined since the information on the continuation of the toolpath 122 (or the information that the toolpath 122 is complete) has not yet been provided. Hence, there is no machine code 124 yet for the fourth arc “Arc 4”. The machine code 124 for the fourth arc “Arc 4” may be determined once information on how the toolpath 122 is continued after the fourth arc “Arc 4” is continued.

Hence, multiple motions in the toolpath 122 may be combined into one motion in the resulting machine code 124. When constructing or determining the map 126, this may pose a special challenge as this demonstrates a special case where there is no 1:1 relationship. According to the suggested approach, the map 126 may reflect rather simple one-to-one-relationships between an entry of the toolpath data 120 and an entry of the machine code 124, but also more complex many-to-one-relationships, e.g. 2:1 or 3:1 relationships, between entries of the toolpath data 120 and an entry of the machine code 124. Hence, an entry of machine code 124 in the map 126 may be linked to two or more entries of toolpath data 120 if such a many-to-one-relationship is present. In some cases, one-to-many-relationships, e.g. 1:2 or 1:3 relationships, between an entry of the toolpath data 120 and two or more entries of the machine code 124 may also occur.

As explained above, the toolpath data 120 may include further information relating to the toolpath 122.

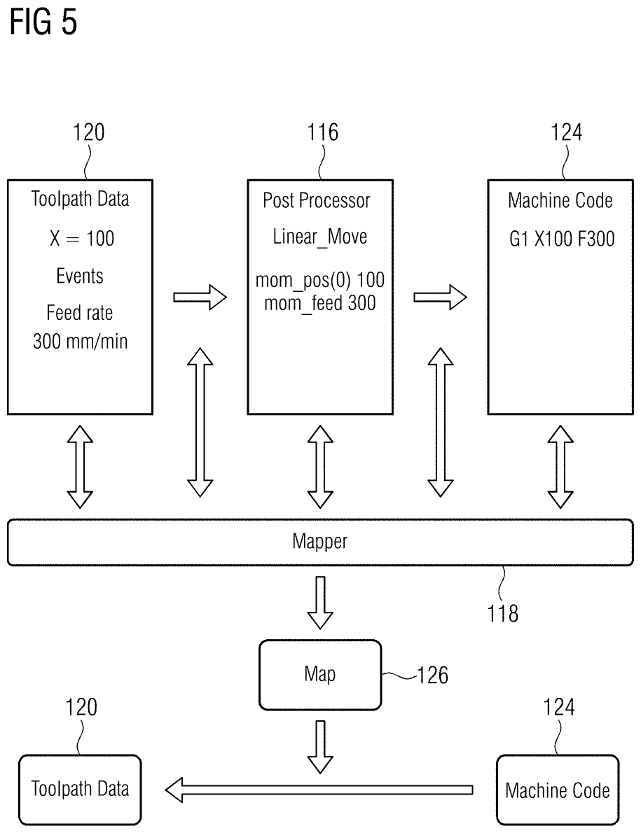

With reference to FIG. 5, an example flow diagram for the creation of the map 126 is illustrated.

The toolpath data 120 relating to the toolpath 122 may be used as input data. This input data may be provided to a post processor 116. The post processor 116 may use the input data and determine corresponding machine code 124 as output data. According to this example, the toolpath data 120 may include positioning information of the tool 130 (e.g., “X=100”) and motion data of the tool (e.g., “Feed rate 300 mm/min”), which may be translated during two subsequent acts into intermediate data (e.g., “mom_pos(0) 100”; “mom_feed 300”) and eventually into machine code 124 (e.g., “G1 X100 F300”).

A mapper 118 may collect at least the toolpath data 120 and the machine code 124 and use this data to create the map 126 that links items of the toolpath data 120 with suitable items of the machine code 124. The mapper 118 may use additional data, such as the intermediate data or machine tool data or the like, to create the map 126 and to store corresponding data in the map 126.

By way of example, the map 126 may be stored in an internal data store 108 of the machine tool and/or in an internal data store 108′ of a computer system, such as a CAD, CAM, PLM, or MOM system. In some examples, the mapper 126 is a software component.

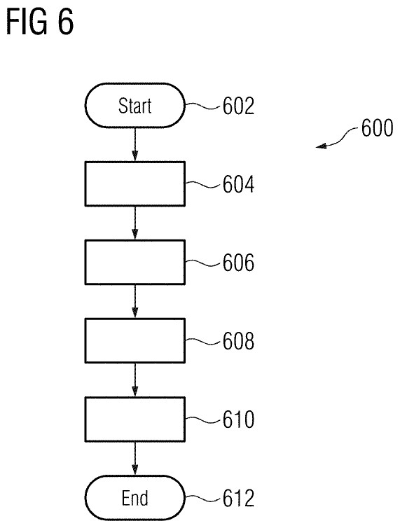

With reference to FIG. 6, a flow diagram of an example methodology 600 that facilitates machining of workpieces using a machine tool (e.g., managing a machine tool) in a product system is illustrated. The method may start at 602, and the methodology may include several acts (e.g., carried out through operation of the control device or processor 102, the processor 102′, the machine tool 132, or the computer system 150).

These acts may include: an act 604 of receiving toolpath data for machining a workpiece 140 with a tool along a toolpath, where the tool is comprised by a machine tool that is numerically controlled by a control device; an act 606 of receiving machine code for the machine tool corresponding to the toolpath data; an act 608 of creating a map linking at least one item of the toolpath data and at least one item of the machine code corresponding to the least one item of the path data; and an act 610 of displaying at least one first item of the toolpath data and the one or more second items of the machine code corresponding or linked to the at least one first item to a user using the created map. At act 612, the methodology may end.

The methodology 600 may include other acts and features discussed previously with respect to the processing system 100 or the computer-implemented method.

For example, the above examples are equally applicable to the control device or processor 102, the processor 102′, the machine tool 132, or the computer system 150, and to the corresponding computer-readable medium 160 explained in the present patent document, respectively.

While the disclosure includes a description in the context of a fully functional system and/or a series of acts, those skilled in the art will appreciate that at least portions of the mechanism of the present disclosure and/or described acts are capable of being distributed in the form of computer-executable instructions contained within non-transitory machine-usable, computer-usable, or computer-readable medium in any of a variety of forms, and that the present disclosure applies equally regardless of the particular type of instruction or data bearing medium or storage medium utilized to actually carry out the distribution. Examples of non-transitory machine usable/readable or computer usable/readable mediums include: ROMs, EPROMs, magnetic tape, floppy disks, hard disk drives, SSDs, flash memory, CDs, DVDs, and Blu-ray disks. The computer-executable instructions may include a routine, a sub-routine, programs, applications, modules, libraries, a thread of execution, and/or the like. Still further, results of acts of the methodologies may be stored in a computer-readable medium, displayed on a display device, and/or the like.

As discussed previously, acts associated with these methodologies (other than any described manual acts such as an act of manually making a selection through the input device) may be carried out by one or more processors. Such processor(s) may be included in one or more data processing systems, for example, that execute software components operative to cause these acts to be carried out by the one or more processors. In an example embodiment, such software components may include computer-executable instructions corresponding to a routine, a sub-routine, programs, applications, modules, libraries, a thread of execution, and/or the like. Further, software components may be written in and/or produced by software environments/languages/frame-works such as Java, JavaScript, Python, C, C#, C++ or any other software tool capable of producing components and graphical user interfaces configured to carry out the acts and features described herein.

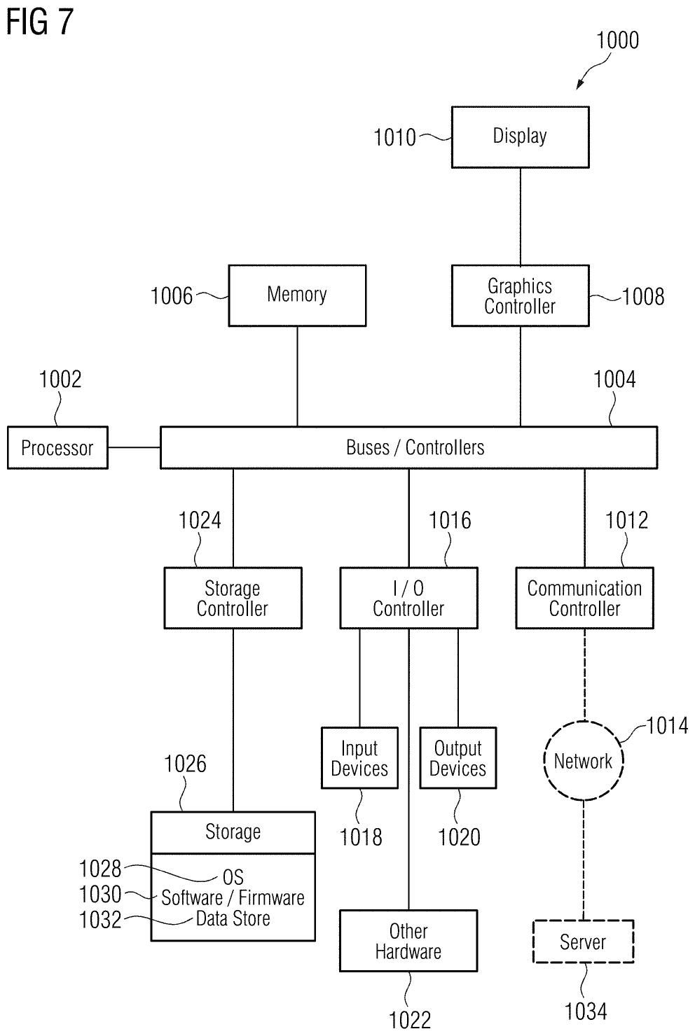

FIG. 7 illustrates a block diagram of a data processing system 1000 (also referred to as a product system, machine tool, computer system) in which an embodiment may be implemented, for example, as a portion of a product system and/or other system operatively configured by software or otherwise to perform the processes as described herein. The data processing system depicted includes at least one processor 1002 (e.g., a CPU) that may be connected to one or more bridges/controllers/buses 1004 (e.g., a north bridge, a south bridge). One of the buses 1004, for example, may include one or more I/O buses such as a PCI Express bus. A main memory 1006 (RAM) and a graphics controller 1008 may also be connected to various buses in the depicted example. The graphics controller 1008 may be connected to one or more display devices 1010. In some embodiments, one or more controllers (e.g., graphics, south bridge) may be integrated with the CPU (e.g., on the same chip or die). Examples of CPU architectures include IA-32, x86-64, and ARM processor architectures.

Other peripherals connected to one or more buses may include communication controllers 1012 (e.g., Ethernet controllers, WiFi controllers, cellular controllers) operative to connect to a local area network (LAN), Wide Area Network (WAN), a cellular network, and/or other wired or wireless networks 1014 or communication equipment.

Further components connected to various busses may include one or more I/O controllers 1016 such as USB controllers, Bluetooth controllers, and/or dedicated audio controllers (e.g., connected to speakers and/or microphones). Various peripherals may be connected to the I/O controller(s) (e.g., via various ports and connections) including input devices 1018 (e.g., keyboard, mouse, pointer, touch screen, touch pad, drawing tablet, trackball, buttons, keypad, game controller, gamepad, camera, microphone, scanners, motion sensing devices that capture motion gestures), output devices 1020 (e.g., printers, speakers) or any other type of device that is operative to provide inputs to or receive outputs from the data processing system. Also, many devices referred to as input devices or output devices may both provide inputs and receive outputs of communications with the data processing system. For example, the processor 1002 may be integrated into a housing (e.g., a tablet) that includes a touch screen that serves as both an input and display device. Further, some input devices (e.g., a laptop) may include a plurality of different types of input devices (e.g., touch screen, touch pad, keyboard). Also, other peripheral hardware 1022 connected to the I/O controllers 1016 may include any type of device, machine, or component that is configured to communicate with a data processing system.

Additional components connected to various busses may include one or more storage controllers 1024 (e.g., SATA). A storage controller may be connected to a storage device 1026 such as one or more storage drives and/or any associated removable media, which may be any suitable non-transitory machine usable or machine-readable storage medium. Examples include nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also, in some examples, a storage device such as an SSD may be connected directly to an I/O bus 1004 such as a PCI Express bus.

A data processing system in accordance with an embodiment of the present disclosure may include an operating system 1028, software/firmware 1030, and data stores 1032 (e.g., that may be stored on a storage device 1026 and/or the memory 1006). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed, and/or an event, such as clicking a mouse button or touching a touch screen, may be generated to actuate a desired response. Examples of operating systems that may be used in a data processing system may include Microsoft Windows, Linux, UNIX, iOS, and Android operating systems. Also, examples of data stores include data files, data tables, relational database (e.g., Oracle, Microsoft SQL Server), database servers, or any other structure and/or device that is capable of storing data, which is retrievable by a processor.

The communication controllers 1012 may be connected to the network 1014 (not a part of data processing system 1000), which may be any public or private data processing system network or combination of networks, as known to those of skill in the art, including the Internet. Data processing system 1000 may communicate over the network 1014 with one or more other data processing systems such as a server 1034 (also not part of the data processing system 1000). However, an alternative data processing system may correspond to a plurality of data processing systems implemented as part of a distributed system in which processors associated with a number of data processing systems may be in communication by way of one or more network connections and may collectively perform tasks described as being performed by a single data processing system. Thus, when referring to a data processing system, such a system may be implemented across a number of data processing systems organized in a distributed system in communication with each other via a network.

Further, the term “controller” may be any device, system, or part thereof that controls at least one operation, whether such a device is implemented in hardware, firmware, software, or some combination of at least two of the same. The functionality associated with any particular controller may be centralized or distributed, whether locally or remotely.

In addition, data processing systems may be implemented as virtual machines in a virtual machine architecture or cloud environment. For example, the processor 1002 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system may vary for particular implementations. For example, the data processing system 1000 in this example may correspond to the above-described control device 6, a computer, workstation, server, PC, notebook computer, tablet, mobile phone, and/or any other type of apparatus/system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

Also, the processor described herein may be located in a server that is remote from the display and input devices described herein. In such an example, the described display device and input device may be included in a client device that communicates with the server (and/or a virtual machine executing on the server) through a wired or wireless network (which may include the Internet). In some embodiments, such a client device, for example, may execute a remote desktop application or may correspond to a portal device that carries out a remote desktop protocol with the server in order to send inputs from an input device to the server and receive visual information from the server to display through a display device. Examples of such remote desktop protocols include Teradici's PCoIP, Microsoft's RDP, and the RFB protocol. In such examples, the processor described herein may correspond to a virtual processor of a virtual machine executing in a physical processor of the server.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein, a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 1000 may conform to any of the various current implementations and practices known in the art.

Also, the words or phrases used herein should be construed broadly, unless expressly limited in some examples. For example, the terms “include” and “comprise,” as well as derivatives thereof, provide inclusion without limitation. The singular forms “a”, “an”, and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may be to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to describe various elements, functions, or acts, these elements, functions, or acts should not be limited by these terms. Rather, these numeral adjectives are used to distinguish different elements, functions, or acts from each other. For example, a first element, function, or act may be termed a second element, function, or act, and, similarly, a second element, function, or act may be termed a first element, function, or act, without departing from the scope of the present disclosure.

In addition, phrases such as “processor is configured to” carry out one or more functions or processes, may be that the processor is operatively configured to or operably configured to carry out the functions or processes via software, firmware, and/or wired circuits. For example, a processor that is configured to carry out a function/process may correspond to a processor that is executing the software/firmware, which is programmed to cause the processor to carry out the function/process and/or may correspond to a processor that has the software/firmware in a memory or storage device that is available to be executed by the processor to carry out the function/process. A processor that is “configured to” carry out one or more functions or processes may also correspond to a processor circuit particularly fabricated or “wired” to carry out the functions or processes (e.g., an ASIC or FPGA design). Further, the phrase “at least one” before an element (e.g., a processor) that is configured to carry out more than one function may correspond to one or more elements (e.g., processors) that each carry out the functions, and may also correspond to two or more of the elements (e.g., processors) that respectively carry out different ones of the one or more different functions.

In addition, the term “adjacent to” may be that an element is relatively near to but not in contact with a further element, or that the element is in contact with the further portion, unless the context clearly indicates otherwise.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present patent document should be read as implying that any particular element, step, act, or function is an essential element that must be included in the claim scope. The scope of patented subject matter is defined only by the allowed claims. Further, none of these claims are intended to invoke 35 USC § 112(f) unless the exact words “means for” are followed by a participle.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A computer-implemented method comprising:
receiving toolpath data for machining a workpiece with a tool along a toolpath, wherein the tool is comprised by a machine tool that is numerically controlled by a control device;
receiving machine code for the machine tool corresponding to the toolpath data;
creating a map linking at least one item of the toolpath data and at least one item of the machine code corresponding to the at least one item of the toolpath data; and
displaying at least one first item of the toolpath data and one or more second items of the machine code corresponding to the at least one first item of the toolpath data to a user using the created map.

2. The computer-implemented method of claim 1, wherein the toolpath data comprises geometry information on a trajectory along which the tool is to be moved, and
wherein the machine code comprises commands that are interpretable by the control device.

3. The computer-implemented method of claim 1, wherein receiving the machine code for the machine tool comprises determining the machine code based on the toolpath data using a post processor software component, and
wherein the method further comprises simultaneously determining the machine code using the post processor software component.

4. The computer-implemented method of claim 1, further comprising:
capturing a user input relating to an amendment of one or more first items of the at least one displayed first item of the toolpath data;
determining amended machine code corresponding to the amended toolpath data using the created map;
updating the map to an updated map linking the one or more amended first items of the toolpath data and one or more amended second items of the amended machine code corresponding to one or more amended first items of the toolpath data; and
displaying at least the one or more amended first items of the toolpath data and the one or more amended second items of the amended machine code linked to the one or more amended first items of the toolpath data using the updated map.

5. The computer-implemented method of claim 1, further comprising:
capturing a user input relating to an amendment of at least one second item of the one or more displayed second items of the machine code;
determining amended toolpath data corresponding to the amended machine code using the created map;
updating the map to an updated map linking the at least one amended second item of the machine code and one or more amended first items of the at least one time of the toolpath data corresponding to the at least one amended second item of the machine code; and
displaying at least the at least one amended second item of the machine code and the one or more amended first items of the toolpath data linked to the at least one amended second item of the machine code using the updated map.

6. The computer-implemented method of claim 1, further comprising receiving machine tool data,
wherein creating the map comprises creating the map such that the map links one or more items of the toolpath data, the machine tool data, and one or more items of the machine code corresponding to the one or more items of the toolpath data, the machine tool data, or the one or more items of the toolpath data and the machine tool data, and
wherein the displaying further comprises displaying the machine tool data.

7. The computer-implemented method of claim 6, wherein the machine tool data comprises at data on axis information, tool wear, tool dimensions, a used coolant, a spindle, a tool changer, coordinate system changes, head, or any combination thereof.

8. The computer-implemented method of claim 1, wherein receiving the toolpath data comprises:
receiving a three-dimensional start shape of the workpiece and a three-dimensional target shape of the workpiece; and
determining the toolpath data based on the three-dimensional start shape of the workpiece and the three-dimensional target shape of the workpiece.

9. The computer-implemented method of claim 1, further comprising:
displaying a plurality of items of the toolpath data to the user;
capturing a user input relating to a selection of at least one item of the plurality of displayed items of the toolpath data;
simulating a machining process until/from the at least one selected item of toolpath data using the created map (126); and
displaying the simulated machining process until/from the at least one selected item of toolpath data to the user.

10. The computer-implemented method of claim 1, further comprising:
displaying a plurality of items of the machine code to a user;
capturing a user input relating to a selection of at least one item of the plurality of displayed items of the machine code;
simulating a machining process until/from the at least one selected item of machine code using the created map; and
displaying the simulated machining process until/from the selected item of machine code to the user.

11. The computer-implemented method of claim 1, further comprising:
determining a machine tool status based on the machine code stored in the map; and
displaying the determined machine tool status for a respective item of the machine code to the user.

12. The computer-implemented method of claim 1, further comprising:
determining a machining duration required for one or more items of the at least one item of the toolpath data, for one or more items of the at least one item of the machine code, or for a combination thereof using one or more respective entries in the map; and
displaying the determined machining duration, the one or more items of the toolpath data and the one or more items of machine code to the user.

13. A control device for numerically controlling a machine tool that comprises a tool for machining a workpiece along a toolpath, the control device comprising:
a processor configured to:
receive toolpath data for machining a workpiece with a tool along a toolpath, wherein the tool is comprised by a machine tool that is numerically controlled by a control device;
receive machine code for the machine tool corresponding to the toolpath data;
create a map linking at least one item of the toolpath data and at least one item of the machine code corresponding to the at least one item of the toolpath data; and
display at least one first item of the toolpath data and one or more second items of the machine code corresponding to the at least one first item of the toolpath data to a user using the created map.

14. A machine tool comprising:
a tool for machining a workpiece along a toolpath; and
a control device for numerically controlling the tool, the control device comprising:
a processor configured to:
receive toolpath data for machining the workpiece with the tool along the toolpath, wherein the tool is comprised by a machine tool that is numerically controlled by a control device;
receive machine code for the machine tool corresponding to the toolpath data;
create a map linking at least one item of the toolpath data and at least one item of the machine code corresponding to the at least one item of the toolpath data; and
display at least one first item of the toolpath data and one or more second items of the machine code corresponding to the at least one first item of the toolpath data to a user using the created map.

15. A non-transitory computer-readable storage medium that stores instructions executable by a control device, the instructions comprising:
receiving toolpath data for machining a workpiece with a tool along a toolpath, wherein the tool is comprised by a machine tool that is numerically controlled by a control device;
receiving machine code for the machine tool corresponding to the toolpath data;
creating a map linking at least one item of the toolpath data and at least one item of the machine code corresponding to the at least one item of the toolpath data; and
displaying at least one first item of the toolpath data and one or more second items of the machine code corresponding to the at least one first item of the toolpath data to a user using the created map.
